(19) United States
(12) Patent Application Publication
(10) Pub. No.: US 2014/0362672 A1
(43) Pub. Date: Dec. 11, 2014

(54) ROTOR MANUFACTURING METHOD, ROTOR, AND TIMEPIECE HAVING ROTOR

(71) Applicant: CASIO COMPUTER CO., LTD., Tokyo (JP)

(72) Inventor: Yuta SAITO, Tokyo (JP)

(73) Assignee: CASIO COMPUTER CO., LTD., Tokyo (JP)

(21) Appl. No.: 14/278,971

(22) Filed: May 15, 2014

(30) Foreign Application Priority Data
Jun. 5, 2013 (JP) 2013-118929

(51) Int. Cl. H02K 15/03; G04C 3/14; H02K 7/116

(52) U.S. Cl. CPC H02K 15/03; H02K 7/116; G04C 3/14
USPC 368/168; 310/83; 29/598

(57) ABSTRACT

In a rotor manufacturing method of the present invention, firstly, a rectangular magnet element whose magnetic pole direction is recognizable is formed by a magnetic material being sintered while a magnetic field is being applied thereto, and subjected to a demagnetization process, and position regulating sections are formed on the magnet element symmetrically relative to the magnetic poles. Accordingly, a magnet can be easily formed. Secondly, the demagnetized magnets are individually transported without being attracted to each other. Accordingly, the direction of each magnetic pole of the demagnetized magnets can be aligned to one direction and successively arranged. Thirdly, when a gear section is to be formed on the magnet, it is positionally adjusted by the position regulating sections so as to have a fixed positional relationship relative to the magnetic poles of the demagnetized magnet. Accordingly, the gear section can be precisely formed relative to the magnetic poles.

### CROSS-REFERENCE TO RELATED APPLICATION

This application is based upon and claims the benefit of priority from the prior Japanese Patent Application No. 2013-118929, filed Jun. 5, 2013, the entire contents of which are incorporated herein by reference.

### BACKGROUND OF THE INVENTION

1. Field of the Invention

The present invention relates to a method for manufacturing a rotor that is rotated in response to a change in a magnetic field, the rotor, and a timepiece provided with the rotor.

2. Description of the Related Art

A rotor for use in an electromagnetic driving device such as a stepping motor is known that has a structure in which, when a drive transmission section including a gear having a shaft section and a transmission arm is to be formed on a magnet by insert molding, it is formed to have a fixed positional relationship relative to the magnetic poles of the magnet, as described in Japanese Patent Application Laid-Open (Kokai) Publication No. 2005-295716.

In this case, the magnet is structured such that a shaft hole having a non-circular shape, such as a square-shaped shaft hole, is formed in its rotation center.

The drive transmission section, which is made of a synthetic resin, has a transmission section including the gear and the transmission arm and the shaft section forming the rotation center of the transmission section, which are integrally formed on the magnet by insert molding.

In the production of a rotor such as this, the magnet is magnetized by a magnetizing device and arranged in a metal mold for molding, and the driving transmission section is molded with resin.

In this process, the magnet is positionally regulated inside the metal mold by its magnetic poles being attracted by positioning members made of soft magnetic members. In this state, the shaft section is formed in the shaft hole of the magnet, and the transmission section including the gear and the transmission arm is formed on an end portion of the shaft section in a manner to have a fixed positional relationship relative to the magnetic poles of the magnet.

However, in this rotor manufacturing method where positioning is performed by the magnetic poles of the magnet being attracted by the positioning members made of soft magnetic members, when magnets are to be transported into the metal mold by a transporting device such as a parts feeder, they are attracted to each other by their magnetic forces, and therefore cannot be arranged with each magnetic pole being aligned in one direction.

In addition, since the positioning members are required to be provided inside the metal mold for molding, the structure is complicated.

For this reason, in this rotor manufacturing method, when magnets are to be arranged inside the metal mold so as to mold the driving transmission section, the transmission section including the gear and the transmission arm cannot be formed to have a fixed positional relationship relative to the magnetic poles unless the magnets are individually arranged inside the metal mold with the directions of their magnetic poles being individually aligned for each magnet. Accordingly, there is a problem in that the productivity is extremely poor.

### SUMMARY OF THE INVENTION

An object of the present invention is to provide a rotor manufacturing method by which gear sections can be precisely formed relative to the magnetic poles of magnets and the productivity can be improved, a rotor manufactured thereby, and a timepiece provided with the rotor.

In accordance with one aspect of the present invention, there is provided a rotor manufacturing method comprising: a first step of forming a magnet by (i) forming a magnet element whose magnetic pole direction is recognizable by sintering a magnetic material while applying a magnetic field to the magnetic material, (ii) performing a demagnetization process on the magnet element, and (iii) forming position regulating sections on the magnet element symmetrically relative to magnetic poles; a second step of aligning a direction of each magnetic pole of the magnet after demagnetization to one direction by the position regulating sections while transporting the magnet so as to successively align magnets; and a third step of (i) forming a gear section on the magnet whose direction of each magnetic pole after the demagnetization has been aligned to one direction such that the gear section has a fixed positional relationship relative to the position regulating sections after the demagnetization, and (ii) performing magnetization processing on the magnet.

In accordance with another aspect of the present invention, there is provided a rotor that is rotated in response to a magnetic field generated in a coil section and directed by a stator section, comprising: a magnet having position regulating sections formed symmetrically relative to magnetic poles, and a shaft hole formed in a rotation center; and a gear section having a gear formed on a shaft section in the shaft hole of the magnet in a manner to have a fixed positional relationship relative to the position regulating sections.

In accordance with another aspect of the present invention, there is provided a timepiece comprising: a stepping motor having a rotor that includes (i) a magnet having position regulating sections formed symmetrically relative to magnetic poles and a shaft hole formed in a rotation center, and (ii) a gear section having a gear formed on a shaft section in the shaft hole of the magnet in a manner to have a fixed positional relationship relative to the position regulating sections.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an enlarged front view of a first embodiment in which the present invention has been applied to a pointer-type wristwatch;

FIG. 2 is an enlarged front view of a stepping motor assembled inside the wristwatch shown in FIG. 1.

FIGS. 3A to 3C depict the rotor of the stepping motor shown in FIG. 2, of which FIG. 3A is an enlarged front view thereof, FIG. 3B is an enlarged side view thereof, and FIG. 3C is an enlarged sectional view thereof taken along line A-A shown in FIG. 3A;

FIG. 4 is an enlarged perspective view depicting the magnet of the rotor shown in FIGS. 3A to 3C;

FIG. 5 is a diagram conceptually depicting a sintering metal mold and a magnetizing device for use in a first process for manufacturing the magnet shown in FIG. 4;

FIG. 6 is a process view depicting the first process for forming the magnet, in which a magnet formed using the sintering metal mold and the magnetizing device shown in FIG. 5 is subjected to a demagnetization process and a cutting process;

FIG. 7 is a perspective view depicting a transporting device in which magnets manufactured in the first process shown in FIG. 6 are aligned, and a metal mold for resin molding to which the magnets are transported by the transporting device;

FIG. 8 is an enlarged planar view of an essential portion, depicting a state in which the magnets aligned by their directions being aligned are being transported in an aligning section of the transporting device shown in FIG. 7;

FIGS. 9A to 9C depict the metal mold for resin molding shown in FIG. 7 when the insert molding of a gear section onto a magnet is being performed thereby, of which FIG. 9A is an enlarged sectional view depicting a state in which a lower metal mold and an upper metal mold have been opened, FIG. 9B is an enlarged sectional view depicting a state in which the magnet has been positionally adjusted and arranged inside the lower metal mold, and FIG. 9C is an enlarged sectional view depicting a state in which the lower metal mold and the upper metal mold have been closed and resin has been filled thereinto;

FIGS. 10A and 10B depict a state in which the magnet of the rotor formed by the resin molding metal mold shown in FIGS. 9A to 9C is magnetized by the magnetizing device, of which FIG. 10A is an enlarged view of an essential portion depicting a state where the magnet has been magnetized with its magnetic poles after demagnetization and the magnetic poles of the magnetizing device corresponding to each other, and FIG. 10B is an enlarged view of the essential portion depicting a state in which, when the magnet is to be magnetized with its magnetic poles after demagnetization and the magnetic poles of the magnetizing device being slightly shifted from each other, it is rotated so that its magnetic poles after demagnetization and the magnetic poles of the magnetizing device correspond to each other;

FIGS. 11A and 11B depict a rotor of a second embodiment in which the present invention has been applied to a wristwatch, of which FIG. 11A is an enlarged front view thereof, and FIG. 11B is an enlarged sectional view thereof taken along line B-B shown in FIG. 11A;

FIG. 12 is an enlarged perspective view depicting the magnet of the rotor shown in FIGS. 11A and 11B;

FIG. 13 is a process view depicting a process for forming the magnet shown in FIG. 12;

FIGS. 14A and 14B depict an aligning section of a transporting device for transporting the magnet shown in FIG. 12, of which FIG. 14A is an enlarged plan view of the main section thereof, and FIG. 14B is an enlarged sectional view thereof taken along line C-C shown in FIG. 14A;

FIGS. 15A and 15B depict a rotor of a third embodiment in which the present invention has been applied to a wristwatch, of which FIG. 15A is an enlarged front view thereof, and FIG. 15B is an enlarged sectional view thereof taken along line D-D shown in FIG. 15A;

FIG. 16 is an enlarged perspective view depicting the magnet of the rotor shown in FIGS. 15A and 15B;

FIG. 17 is a process view depicting a process for forming the magnet shown in FIG. 16; and

FIG. 18 is an enlarged front view of an essential portion depicting an aligning section of a transporting device for transporting the magnet shown in FIG. 16.

### DETAILED DESCRIPTION OF THE PREFERRED EMBODIMENTS

### First Embodiment

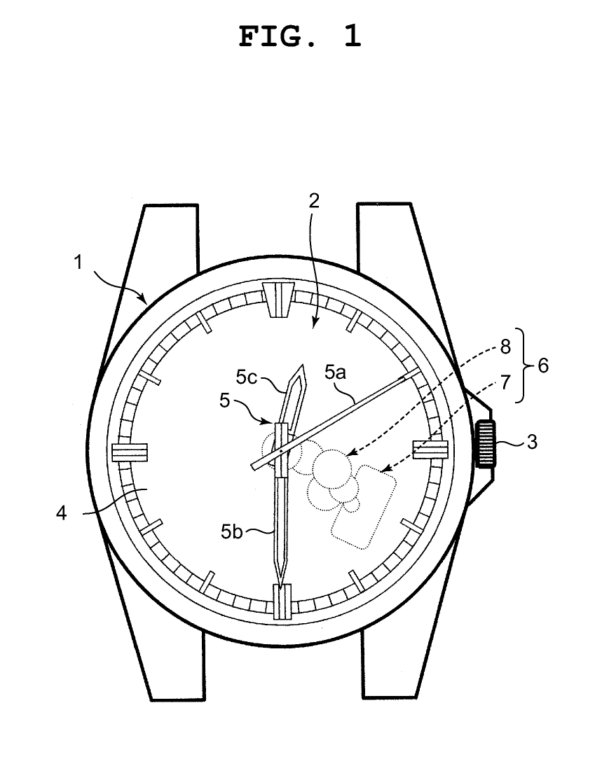

Hereinafter, a first embodiment in which the present invention has been applied to a pointer-type wristwatch is described with reference to FIG. 1 to FIG. 10B.

As shown in FIG. 1, this pointer-type wristwatch is provided with a wristwatch case 1.

This wristwatch case 1 is structured such that a watch module 2 is provided inside thereof and a switch section 3 for correcting time is formed on a side face on the 3-o'clock side.

The watch module 2 is provided with a pointer 5 that moves above a dial plate 4, and a watch movement 6 for driving the pointer 5.

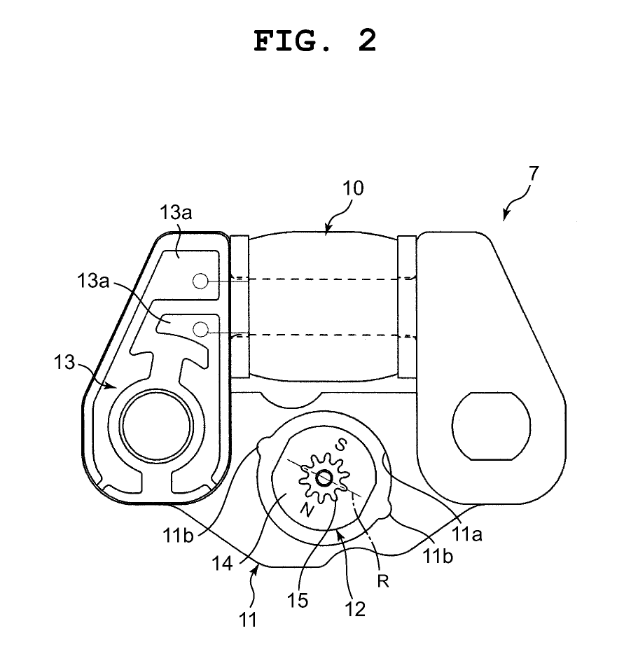

The watch movement 6 is structured to transmit the rotation of a stepping motor 7 to a pointer axis (not shown) by a gear train mechanism 8 so as to move the pointer 5, as shown in FIGS. 1 and 2.

In this embodiment, the pointer 5 includes a second pointer 5a, a minute pointer 5b, and an hour pointer 5c.

The gear train mechanism 8 is provided with a plurality of gears, and structured to successively transmit rotations of the stepping motor 7 by these gears so as to rotate the pointer axis.

In the gear train mechanism 8, a pointer position detecting section (not shown) for detecting the pointer position of the pointer 5 is provided.

This pointer position detecting section includes a detection hole formed on one of the plural gears of the gear train mechanism 8, and a detection element for detecting this detection hole.

As a result, the pointer position detecting section is structured to detect the pointer position of the pointer 5 by detecting the rotation position of the gear by the detection of the detection hole of the gear using the detection element, and the time indicated by the pointer 5 is corrected based on the detection result.

The stepping motor 7 is provided with a coil section 10, a stator section 11, and a rotor 12, as shown in FIG. 2.

The coil section 10 is structured such that the two ends of the coil are connected to the respective electrodes 13a of a wiring substrate 13 formed on a stator section 11, and a magnetic field is generated when an electric current is supplied thereto through the wiring substrate 13.

As shown in FIG. 2, the stator section 11 is provided with a rotor hole 11a where the rotor 12 is arranged in the middle portion thereof, and structured to direct a magnetic field generated by the coil section 10 toward the rotor hole 11a.

In this structure, on the inner circumferential surface of the rotor hole 11a of the stator section 11, a pair of notches 11b are formed opposing each other.

These notches 11b are provided in areas tilted at a predetermined angle relative to the magnetic flux of the magnetic field directed by the stator section 11, and used to restrict the rotation position of the rotor 12.

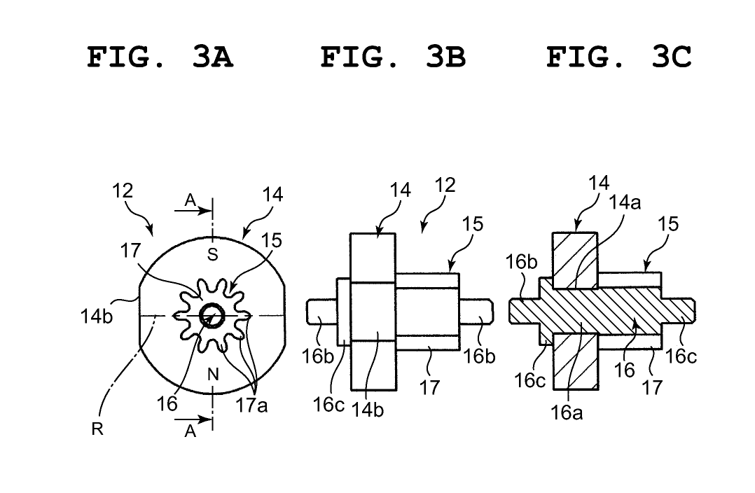

The rotor 12 includes a magnet 14 and a gear section 15, as shown in FIG. 2 and FIGS. 3A to 3C. This rotor 12 is rotatably arranged inside the rotor hole 11a of the stator section 11, and rotates step by step by 180 degrees in response to a magnetic field directed by the stator section 11.

In this embodiment, the magnet 14 is formed into a substantially circular shape and provided with its magnetic poles N and S being opposed to each other.

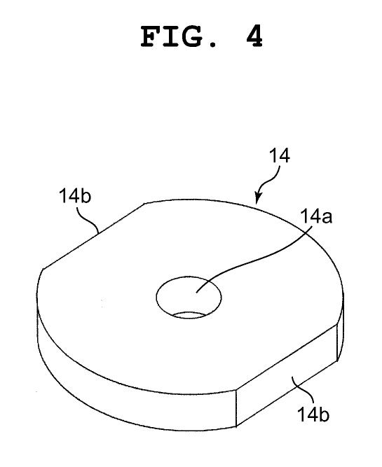

This magnet 14 has a shaft hole 14a provided in its rotation center in a manner to penetrate therethrough, and a pair of position regulating sections 14b formed opposing each other on outer circumferential portions where the polarization line R dividing the two magnetic poles is located, as shown in FIGS. 3A to 3C and FIG. 4.

These position regulating sections 14b are cut-out sections formed by cutting out the outer circumferential portions of the magnet 14 in a direction orthogonal to the polarization line R, and the respective cut surfaces are in parallel with each other.

The gear section 15 includes a shaft section 16 and a gear 17, which are integrally formed by using a synthetic resin, as shown in FIGS. 3A to 3C.

In this embodiment, the shaft section 16 includes a shaft main body 16a which is located inside the shaft hole 14a of the magnet 14 and on which the gear 17 is formed, rotation support sections 16b formed on the two ends of the shaft main body 16a, and a flange section 16c that comes in contact with one surface (left surface in FIG. 3C) of the magnet 14 on the side opposite to the gear 17.

The gear 17 is a small gear, and integrally formed with the shaft main body 16a of the shaft section 16, as shown in FIGS. 3A to 3C. This gear 17 comes in contact with the other surface (right surface in FIG. 3C) of the magnet 14 on the side opposite to the flange section 16c of the shaft section 16, and is rotated in this state together with the magnet 14.

In this embodiment, the gear 17 is formed having an even number of gear teeth in a manner to have a fixed positional relationship relative to the magnetic poles (NS) of the magnet 14, as shown in FIG. 3A.

That is, the gear 17 is formed having a positional relationship where two teeth sections 17a opposing each other, that is, two teeth sections 17a located on a straight line passing through the center of the gear 17 in a radial direction are positioned on the polarization line R dividing the two magnetic poles of the magnet 14.

As a result, the rotor 12 is structured such that, when the magnet 14 is arranged inside the rotor hole 11a of the stator section 11, the magnet 14 and the gear section 15 are integrally rotated centering on the shaft section 16 of the gear section 15 in a state where the extending line of the polarization line R dividing the two magnetic poles of the magnet 14 are coinciding with the pair of notches 11b formed in the inner circumferential surface of the rotor hole 11a, as shown in FIG. 2.

Also, the rotor 12 is structured such that, when the gear 17 of the gear section 15 meshing with one of the plural gears of the gear train mechanism 8 is rotated, this rotation is transmitted to the pointer axis (not shown) by the plural gears of the gear train mechanism 8, so that the pointer axis is rotated and thereby the pointer 5 is moved, as shown in FIG. 1.

As a result, in the stepping motor 7, when an alternating magnetic field is generated by an alternating electric current being supplied to the coil section 10 and is directed to the rotor 12 by the stator section 11, the magnet 14 of the rotor 12 rotates step by step by 180 degrees in response to this alternating magnetic field, inside the rotor hole 11a of the stator section 11, as shown in FIG. 1 and FIG. 2.

Then, this step rotation is transmitted to the pointer axis (not shown) by the gear 17 of the gear section 15 via the gear train mechanism 8, and the pointer 5 is moved in response to this rotation of the pointer axis.

Next, a method for manufacturing the rotor 12 of this stepping motor 7 is described.

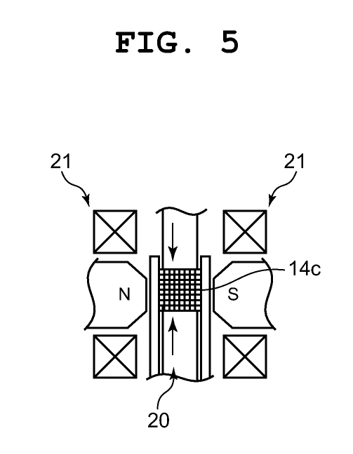

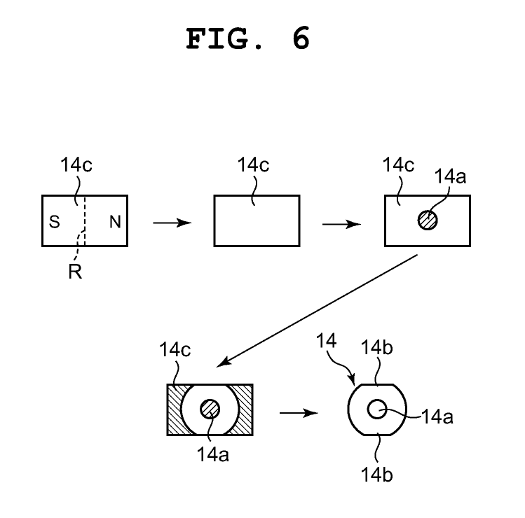

First, in the first process, a magnet element 14c whose magnetic pole direction is recognizable is formed by a magnetic material being sintered while a magnetic field is being applied thereto, and then is subjected to a demagnetization process, as shown in FIG. 5 and FIG. 6.

Then, a shaft hole 14a is formed in the magnet element 14c, and position regulating sections 14b are formed symmetrically relative to the magnetic poles (NS).

That is, in this first process, magnetic material powder that serves as material for the magnet element 14c is filled into a sintering metal mold 20, and sintered in this state while a magnetic field and a pressure are being applied thereto. As a result, the magnet element 14c is formed having an outside shape that makes the magnetic pole direction recognizable, as shown in FIG. 5.

In this embodiment, the magnetic material powder serving as the material for the magnet element 14c is powder mainly composed of neodymium, mixed powder of samarium and cobalt, or the like.

In the sintering of the magnetic material powder in the sintering metal mold 20, the magnetic material powder inside the sintering metal mold 20 is compressed and sintered while a magnetic field being applied thereto from electromagnets 21 formed on the periphery of the sintering metal mold 20, as shown in FIG. 5.

As a result, the magnet element 14c having a rectangular shape which makes the magnetic pole direction recognizable is formed, as shown in FIG. 6.

This magnet element 14c has magnetic poles (NS) formed on the end portions thereof in the longitudinal direction.

Then, the magnet element 14c is taken out of the sintering metal mold 20, and subjected to a demagnetization process by a demagnetizing device (not shown), as shown in FIG. 6. In this state, the magnetic poles remain in the magnet element 14c as magnetic poles after the demagnetization.

Next, the demagnetized magnet element 14c is subjected to a cutting process, so that the shaft hole 14a is formed in the rotation center portion of the magnet element 14c and the magnet element 14c is cut into a substantially circular shape centered on this shaft hole 14a.

In this processing, the cutting process is performed such that the magnet element 14c is formed into a circular shape having a diameter longer than a length in a direction orthogonal to the longitudinal direction of the magnet element 14c, as shown in FIG. 6.

As a result, the magnet 14 is formed into a substantially circular shape.

This magnet 14 has the pair of position regulating sections 14b formed on a polarization line R dividing the two magnetic poles, as shown in FIG. 3A.

That is, the pair of position regulating sections 14b are portions of the longer sides of the magnet element 14c having a rectangular shape which remain without being cut and removed and are in parallel with each other.

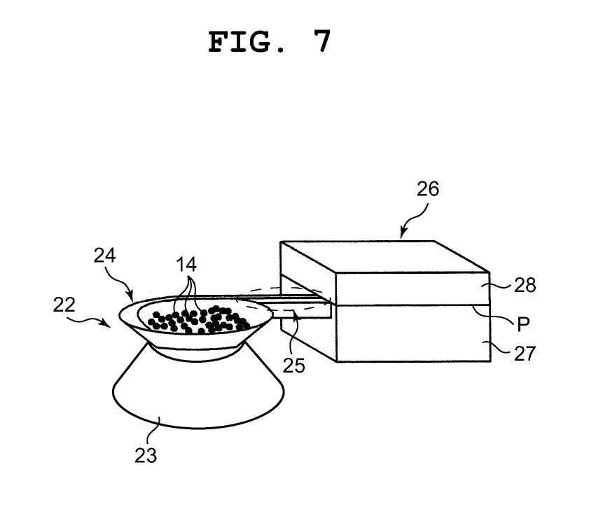

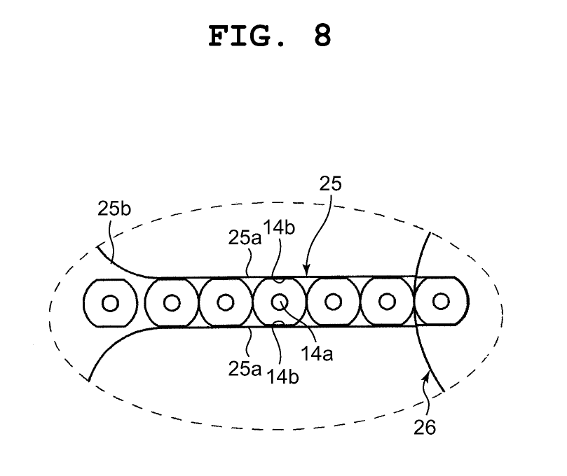

Next, in the second process, the direction of each magnetic pole of the magnets 14 after the demagnetization process is aligned to one direction by the pair of position regulating sections 14b while the magnets 14 are being transported, and the magnets 14 are successively arranged, as shown in FIG. 7 and FIG. 8.

That is, in this second process, a transporting device 22 regulates the positions of the position regulating sections 14b of each magnet 14 while transporting the magnets 14 in a demagnetized state.

As a result, the magnets 14 are successively arranged with the direction of each magnetic pole after the demagnetization being aligned to one direction.

In this embodiment, the transporting device 22 used in the second process is a parts feeder, which is structured to send the magnets 14 placed in a hopper section 24 to an alignment section 25 by vibrating the hopper section 24 by a vibration generating section 23, and align the magnets 14 into one row with their directions being aligned in the alignment section 25, as shown in FIG. 7 and FIG. 8.

In this case, since the magnets 14 have been demagnetized, they are individually transported by the transporting device 22 without being attracted to one another by magnetic forces.

The hopper section 24 of the transporting device 22 is a receiving container where a plurality of magnets 14 are placed, in which a helical-shaped guide section (not shown) is formed on its inner circumferential surface from the bottom to the upper edge portion thereof, as shown in FIG. 7.

When the hopper section 24 is vibrated by the vibration generating section 23, the magnets 14 are moved from the bottom toward the upper edge portion along the helical-shaped guide section, and then sent one by one to the alignment section 25.

The alignment section 25 is formed into a groove shape having guide sections 25a formed on two sides thereof, as shown in FIG. 7 and FIG. 8.

That is, the alignment section 25 is provided having a thin elongated shape protruding from the upper edge of the hopper section 24 with a width substantially the same as a length in a direction orthogonal to the longitudinal direction of the magnet 14 formed in the sintering metal mold 20, that is, a width substantially the same as the length between the pair of position regulating sections 14b of the magnet 14.

As a result, the guide sections 25a are structured such that the pair of position regulating sections 14b of the magnet 14 is in contact with the guide sections 25a while the magnet 14 is being moved therein.

Also, at a portion of the alignment section 25 located on the upper edge of the hopper section 24, a sorting section 25b formed to be gradually narrowed from the hopper section 24 toward the alignment section 25 is provided, as shown in FIG. 8.

This sorting section 25b is structured to align the directions of the magnets 14 so that the longitudinal direction of each magnet 14, that is, the magnetic pole direction thereof is directed to the forward direction with the short sides orthogonal to the longitudinal direction, that is, the pair of position regulating sections 14b being directed to face the guide sections 25a.

The alignment section 25 is structured to vibrate together with the hopper section 24 by the vibration of the vibration generating section 23 and transport the magnets 14 by the vibration, as shown in FIG. 7.

As a result, the alignment section 25 is structured to sort the directions of the magnets 14 by the sorting section 25b when the magnets 14 are sent from the hopper section 24 to the alignment section 25, and transport the magnets 14 whose directions have been sorted while aligning them by the guiding section 25a, as shown in FIG. 8.

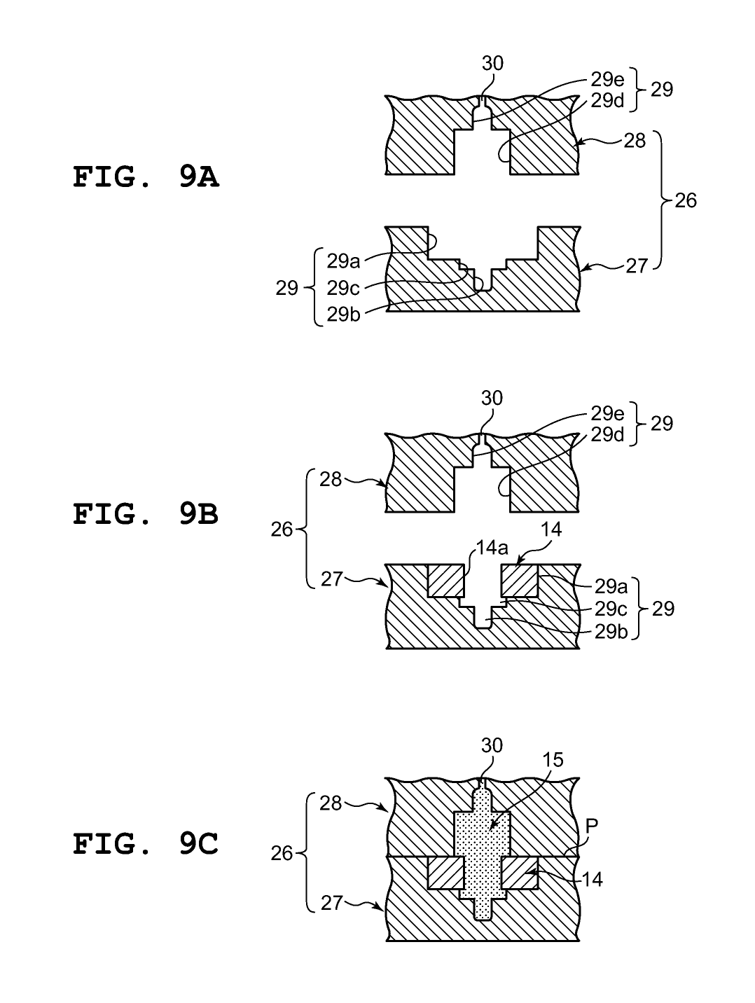

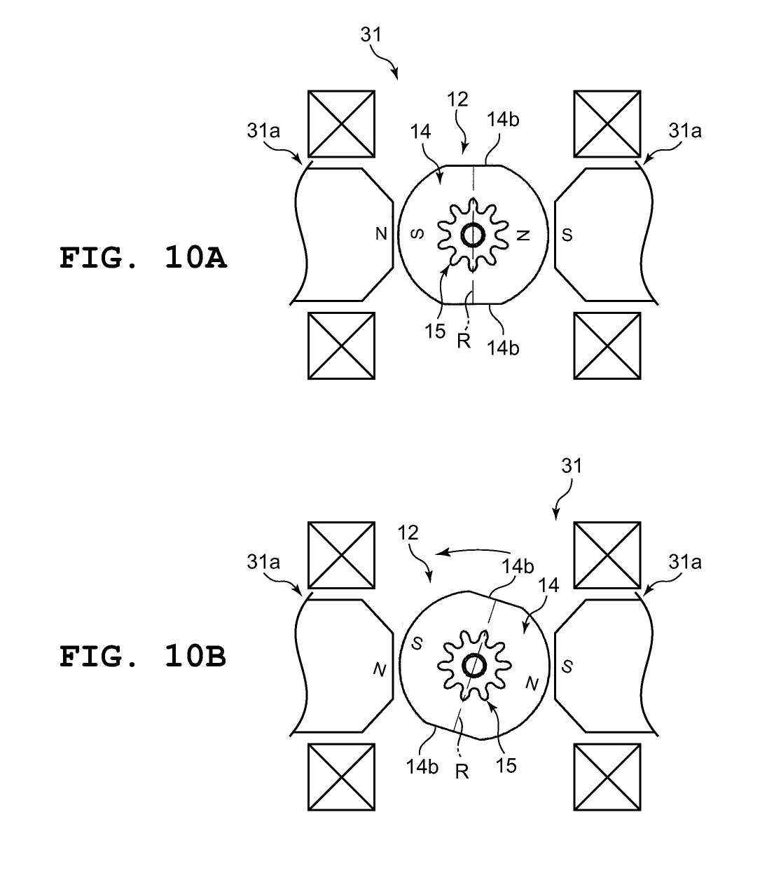

Next, in the third process, the gear section 15 is formed on the magnet 14 whose direction of each magnetic pole after the demagnetization has been aligned to one direction, with a fixed positional relationship relative to the magnetic poles of the magnet 14 after the demagnetization, and the magnet 14 is subjected to magnetization processing in this state, as shown in FIGS. 9A to 9C and FIG. 10A and FIG. 10B.

That is, in the third process, the magnet 14 whose direction of each magnetic pole after the demagnetization has been aligned to one direction is positionally regulated by the position regulating section 14b and arranged inside the resin molding metal mold 26, and resin is injected into the resin molding metal mold 26 in this state so that the gear section 15 is formed, as shown in FIGS. 9A to 9C.

In this embodiment, the resin molding metal mold 26 includes a lower metal mold 27 and an upper metal mold 28 horizontally separated from each other along a parting line P, as shown in FIGS. 9A to 9C. When the lower metal mold 27 and the upper metal mold 28 are superposed on each other along the parting line P, a hollow section (cavity) 29 that is used to form the gear section 15 is formed therein.

Specifically, the hollow section 29 in the lower metal mold 27 of the resin molding metal mold 26 is provided with a magnet arranging section 29a where the magnet 14 is arranged, a shaft-forming section 29b that is used to form one of rotation support sections 16b (lower side in FIG. 9A) of the gear section 15, and a flange-forming section 29c that is used to form a flange section 16c, as shown in FIGS. 9A to 9C.

In this embodiment, the magnet arranging section 29a has an inner circumferential surface formed having the same shape as the outer circumferential surface of the magnet 14, that is, arch-shaped circumferential surfaces on which arch surfaces located in the magnetic pole direction are positioned, and position regulating surfaces on which the flat surfaces of the position regulating sections 14b located in the polarization line R direction are positioned.

As a result, the magnet arranging section 29a is structured such that, when the magnets 14 are placed into the hollow section 29 of the lower metal mold 27, the position regulating sections 14b are positionally regulated, and thereby the magnets 14 are positionally adjusted with their directions being aligned.

Also, the hollow section 29 in the upper metal mold 28 is provided with a gear-forming section 29d that is used to form the gear 17 of the gear section 15, and a shaft-forming section 29e that is used to form the other rotation support section 16b (upper side in FIG. 9A) of the gear section 15, as shown in FIGS. 9A to 9C.

In addition, in the upper metal mold 28, a gate section 30 that is used to inject resin into the hollow section 29 is formed on the upper end surface of the shaft-forming section 29e.

As a result, in the resin-molding metal mold 26, when the magnet 14 is placed into the hollow section 29 of the lower metal mold 27 with the lower metal mold 27 and the upper metal mold 28 being opened, the magnet 14 is positionally regulated and arranged on the magnet arranging section 29a, as shown in FIGS. 9A to 9C. Then, in this state, when the lower metal mold 27 and the upper metal mold 28 are closed and superposed on each other and resin is injected into the hollow section 29 from the gate section 30 of the upper metal mold 28, the gear section 15 is integrally formed with the magnet 14, as shown in FIGS. 9A to 9C.

Here, the shaft main body 16a of the shaft section 16 in the gear section 15 is formed inside the shaft hole 14a of the magnet 14, the respective rotation support sections 16b on the ends of the shaft section 16 protrude from the magnet 14, the flange section 16c comes in contact with one surface (lower surface in FIG. 9C) of the magnet 14, the gear 17 of the gear section 15 comes in contact with the other surface (upper surface in FIG. 9C) of the magnet 14, and the magnet 14 and the gear section 15 are integrally formed in this state, as shown in FIG. 9C.

Here, the gear section 15 is molded with a fixed positional relationship relative to the magnetic poles of the magnet 14 after the demagnetization, as shown in FIG. 3A.

That is, the gear 17 of the gear section 15 is formed having a positional relationship where two opposing teeth sections 17a, that is, two teeth sections 17a located on a straight line passing through the center of the gear 17 in a radial direction are positioned on the polarization line R dividing the two magnetic poles of the magnet 14.

Then, the lower metal mold 27 and upper metal mold 28 shown in FIG. 9C are opened, the magnet 14 and the gear section 15 which have been integrally formed are taken out of the resin molding metal mold 26, and the taken-out magnet 14 is subjected to magnetization processing by a magnetizing device 31.

Here, the magnet 14 is rotatably arranged between the pair of electromagnets 31a of the magnetizing device 31, as shown in FIG. 10A and FIG. 10B.

In addition, the N pole of the magnetic poles of the magnet 14 after the demagnetization is positioned corresponding to an S pole generated by the electromagnets 31a, the S pole of the magnetic poles of the magnet 14 after the demagnetization is positioned corresponding to an N pole generated by the electromagnets 31a, and the magnet 14 is magnetized in this state.

In this case, as shown in FIG. 10B, even if the N pole of the magnetic poles of the magnet 14 after the demagnetization is at a position slightly shifted from the S pole of the electromagnets 31a and the S pole of the magnetic poles of the magnet 14 after the demagnetization is at a position slightly shifted from the N pole of the electromagnets 31a, the respective magnetic poles of the magnet 14 after the demagnetization are attracted by the magnetic poles generated by the electromagnets 31a, and thereby the magnet 14 is rotated.

That is, the respective magnetic poles of the magnet 14 after the demagnetization are attracted by the magnetic poles of the electromagnets 31a, and thereby the magnet 14 is rotated, as shown in FIG. 10B.

As a result, the N pole of the magnetic poles of the magnet 14 after the demagnetization is positioned corresponding to the S pole of the electromagnets 31a, and the S pole of the magnetic poles of the magnet 14 after the demagnetization is positioned corresponding to the N pole of the electromagnets 31a.

Then, the rotor 12 is acquired in which the magnetic poles of the magnet 14 have been magnetized with a fixed positional relationship relative to the gear section 15, as shown in FIG. 3A.

Next, the operation of the stepping motor 7 having this rotor 12 is described.

In this stepping motor 7, the rotor 12 is rotatably arranged inside the rotor hole 11a of the stator section 11, as shown in FIG. 2.

Here, the rotor 12 is arranged inside the rotor hole 11a of the stator section 11 with the polarization line R, which is dividing the two magnetic poles of the magnet 14 of the rotor 12, coinciding with a pair of notches 11b formed on the inner circumferential surface of the rotor hole 11a of the stator section 11.

In this state, when an alternating electric current is supplied to the coil section 10, an alternating magnetic field is generated in the coil section 10, and then directed toward the rotor 12 by the stator section 11.

Then, in response to this alternating magnetic field, the magnet 14 of the rotor 12 rotates step by step by 180 degrees inside the rotor hole 11a of the stator section 11.

As a result, the gear section 15 of the rotor 12 is integrally rotated together with the magnet 14.

Next, the operation of a wristwatch having this stepping motor 7 is described.

In this wristwatch, when the rotor 12 of the stepping motor 7 is rotated, the gear 17 formed on the gear section 15 of the rotor 12 is rotated.

The rotation of this gear 17 is successively transmitted by the plural gears of the gear train mechanism 8, whereby the pointer axis (not shown) is rotated.

As a result, in response to the rotation of the pointer axis, the pointer 5 is moved above the dial plate 4 so as to indicate the time.

Here, if the time indicated by the pointer 5 is different from the standard time, the time indicated by the pointer 5 is corrected.

In this case, the current pointer position of the pointer 5 is detected by the pointer position detecting section (not shown) of the gear train mechanism 8, and the time is corrected based thereon.

That is, the detection hole formed on one of the plural gears of the gear train mechanism 8 is detected by the detection element, and a difference between the time indicated by the pointer 5 and the standard time is calculated. Then, based on the calculation result, the stepping motor 7 is driven so that the pointer 5 is moved.

As a result, the time is corrected.

In this case, since the magnetic poles of the magnet 14 have been magnetized with a fixed positional relationship relative to the gear section 15, the rotation position of the magnet 14 of the rotor 12 and the rotation position of the gear 17 of the gear section 15 coincide with each other, or in other words, the polarization line R of the magnet 14 and two opposing teeth sections 17a of the gear 17 coincide with each other, which coincide with the pair of notches 11b of the stator section 11.

Therefore, the rotation position of the magnet 14 of the rotor 12 and the indication position indicated by the pointer 5 coincide with each other when the rotor 12 of the stepping motor 7 is rotated and the pointer 5 is moved.

With this, in order to improve the detection accuracy of the pointer position detecting section, the detection hole in one of the plural gears of the gear train mechanism 8 is formed having a small size and thereby prevented from being in a half-opened state in which only the half of the detection hole is closed, which makes it possible to unfailingly detect the detection hole formed in one of the gears of the gear train mechanism 8 by the detection element of the pointer position detecting section (not shown), and to accurately correct the pointer position of the pointer 5.

As such, in this method for manufacturing the rotor 12 for use in the stepping motor 7 of a wristwatch, in the first process, the magnet element 14c whose magnetic pole direction is recognizable is formed by a magnetic material being sintered while a magnetic field is being applied thereto, and the magnet 14 is formed by the magnet element 14c being demagnetized and the position regulating sections 14b being symmetrically formed relative to the magnetic poles. In the second process, the direction of each magnetic pole of the magnets 14 after the demagnetization is aligned to one direction by the position regulating section 14b while the magnets 14 are being transported, and then the magnets 14 are successively arranged. In the third process, the gear section 15 is formed on the magnet 14 whose direction of each magnetic pole after the demagnetization has been aligned to one direction, with a fixed positional relationship relative to the magnetic poles of the magnet 14 after the demagnetization, and then the magnet 14 is magnetized. Therefore, the position of the gear section 15 relative to the magnetic poles of the magnet 14 can be precisely determined, whereby the productivity is improved.

That is, in the method for manufacturing the rotor 12, each of the magnets 14 on which the pair of the position regulating sections 14b have been symmetrically formed relative to the magnetic poles in the first process is demagnetized, whereby the magnets 14 are prevented from being attracted to each other in the second process.

Since the magnets 14 can be individually transported thereby in the second process, the direction of each magnetic pole of the magnets 14 after the demagnetization can be aligned to one direction by the position regulating sections 14b, and the magnets 14 can be successively arranged.

As a result, in the third process, when the gear section 15 is to be formed on the magnet 14 whose direction of each magnetic pole after the demagnetization has been aligned to one direction, the gear section 15 can be precisely positioned with a fixed positional relationship relative to the magnetic poles of the magnets 14 after the demagnetization.

Accordingly, the gear section 15 is precisely formed relative to the magnetic poles of the magnet 14, whereby the productivity is improved and good productivity is achieved.

In this embodiment, in the first process, magnetic material powder is filled into the sintering metal mold 20 and sintered in this state while a magnetic field is being applied thereto.

Therefore, the rectangular magnet element 14c whose magnetic pole direction is recognizable can be easily formed.

Then, after the magnet element 14c is taken out of the sintering metal mold 20 and subjected to a demagnetization process, the shaft hole 14a can be formed in the rotation center of the magnet element 14c by a cutting process and the pair of position regulating sections 14b can be formed on the polarization line R dividing the two magnetic poles of the magnet element 14c.

That is, since the magnet element 14c molded in the sintering metal mold 20 has the rectangular shape which makes the magnetic pole direction recognizable, the magnetic pole direction of the magnet element 14c can be recognized by this rectangular outer shape.

Accordingly, in the cutting process on the magnet element 14c after the demagnetization process, the shaft hole 14a can be precisely and easily formed in the center of the rectangular-shaped magnet element 14c, and the pair of position regulating sections 14b can be precisely and easily formed on the polarization line R dividing the two magnetic poles of the magnet element 14c.

In this case, when the pair of position regulating sections 14b are to be formed, the magnet element 14c is cut into a circular shape having a diameter longer than a length in a direction orthogonal to the longitudinal direction of the magnet element 14c centered on the shaft hole 14a.

As a result, the pair of position regulating sections 14b can be precisely and easily formed with them being orthogonal to the polarization line R dividing the two magnetic poles of the magnet element 14.

As a result, the magnet 14 can be formed with high precision.

Also, in the second process, the transporting device 22 for transporting the magnets 14 in a demagnetized state positionally regulates the pair of position regulating sections 14b of each magnet 14 while transporting the magnets 14.

Therefore, the magnets 14 can be transported by the transporting device 22 without being attracted to each other, and the direction of each magnetic pole of the magnets 22 after the demagnetization can be aligned to one direction, whereby the magnets 14 can be successively arranged.

In this embodiment, the transporting device 22 is a parts feeder structured such that the magnets 14 placed into the hopper section 24 are sent to the alignment section 25 by the hopper section 24 being vibrated by the vibration generating section 23, and the directions of the magnets 14 are aligned in the alignment section 25 so that the magnets 14 are aligned in one row.

Therefore, by the plural magnets 14 being placed into the hopper section 24 and the vibration generating section 23 being vibrated, the plural magnets 14 can be successively sent from the hopper section 24 to the alignment section 25 one by one automatically, and arranged by their directions being individually aligned in the alignment section 25 one by one.

Also, in the third process, when the magnet 14 whose direction of each magnetic pole after the demagnetization has been aligned to one direction is to be arranged inside the resin molding metal mold 26, it can be positionally regulated by the pair of position regulating sections 14b and then arranged therein.

In this state, by resin being injected into the resin molding metal mold 26, the gear section 15 can be formed having a fixed positional relationship relative to the magnetic poles of the magnet 14 after the demagnetization.

Then, by magnetization processing being performed on the magnet 14 having the formed gear section 15 in accordance with the magnetic poles after the demagnetization, the magnet 14 can be precisely magnetized.

That is, the resin molding metal mold 26 includes the lower metal mold 27 and upper metal mold 28 and, when they are superposed on each other along the parting line P, the hollow section (cavity) 29 for use in forming the gear section 15 is formed therein.

In this embodiment, in the hollow section 29 of the lower metal mold 27, the magnet arranging section 29a where the magnet 14 is arranged is formed.

Therefore, when the magnet 14 is placed into the hollow section 29 of the lower metal mold 27, the pair of position regulating sections 14b of the magnet 14 are positionally regulated by the magnet arranging section 29a, and thereby the magnet 14 can be precisely arranged with its direction being aligned.

Accordingly, when the gear section 15 is to be formed after the lower metal mold 27 and the upper metal mold 28 are superposed on each other, the gear section 15 can be formed with a fixed positional relationship relative to the magnetic poles of the magnet 14 after the demagnetization.

That is, the magnet 14 is positionally regulated and arranged inside the resin molding metal mold 26 with its direction being aligned by the pair of position regulating sections 14b.

Therefore, the gear 17 of the gear section 15 can be precisely formed having the positional relationship where two opposing teeth sections 17a, that is, two teeth sections 17a located on a straight line passing through the center of the gear 17 in a radial direction are positioned on the polarization line R of the magnet 14.

Then, the magnet 14 integrally formed with the gear section 15 is taken out of the resin molding metal mold 26, and rotatably arranged between the pair of electromagnets 31a of the magnetizing device 31 when it is magnetized by the magnetizing device 31.

Then, the magnet 14 is magnetized with the N pole of the magnetic poles of the magnet 14 after the demagnetization coinciding with an S pole generated by the electromagnets 31a and the S pole of the magnetic poles of the magnet 14 after the demagnetization coinciding with an N pole generated by the electromagnets 31a.

Accordingly, the magnet 14 can be precisely and unfailingly magnetized.

Here, even if the N pole of the magnetic poles of the magnet 14 after the demagnetization is at a position slightly shifted from the S pole of the electromagnets 31a and the S pole of the magnetic poles of the magnet 14 after the demagnetization is at a position slightly shifted from the N pole of the electromagnets 31a, the magnetic poles of the magnet 14 after the demagnetization unfailingly coincide with the magnetic poles of the electromagnets 31a of the magnetizing device 31 by being attracted by the magnetic poles generated by the electromagnets 31a and the magnet 14 being rotated thereby.

Accordingly, the magnet 14 can be precisely and unfailingly magnetized with its magnetic poles having a fixed positional relationship relative to the gear section 15.

This rotor 12, which is manufactured as described above and in which a magnetic field generated by the coil section 10 is directed by the stator section 11 so that the rotor 12 is rotated by the directed magnetic field, includes the magnet 14 which has the pair of position regulating sections 14b formed symmetrically relative to the magnetic poles and in which the shaft hole 14a has been formed in the rotation center thereof, and the gear section 15 in which the gear 17 has been formed on the shaft section 16 formed in the shaft hole 14a of the magnet 14 with a fixed positional relationship relative to the magnetic poles of the magnet 14.

As a result, the rotation position of the magnetic poles of the magnet 14 and the rotation position of the gear 17 of the gear section 16 coincide with each other so that they are precisely rotated.

That is, in the stepping motor 7 using this rotor 12, the rotor 12 can be arranged inside the rotor hole 11a of the stator section 11 with the polarization line R, which is dividing the two magnetic poles of the magnet 14 of the rotor 12, precisely coinciding with the pair of notches 11b formed on the inner circumferential surface of the rotor hole 11a of the stator section 11.

As a result, when an alternating magnetic field is generated in the coil section 10 and the alternating magnetic field is directed toward the rotor 12 by the stator section 11, the magnet 14 of the rotor 12 can be rotated step by step by 180 degrees inside the rotor hole 11a of the stator section 11 in response to the directed alternating magnetic field.

Accordingly, with the rotation position of the magnetic poles of the magnet 14 and the rotation position of the gear 17 of the gear section 16 having a fixed positional relationship, they can be precisely rotated.

Also, in a wristwatch using this stepping motor 7, when the rotor 12 of the stepping motor 7 is rotated, the gear 17 formed in the gear section 15 of the rotor 12 is rotated, and the rotation of the gear 17 is successively transmitted to the pointer axis (not shown) by the plural gears of the gear train mechanism 8. Accordingly, the pointer axis is rotated and thereby the pointer 5 is moved above the dial plate 4.

As a result, the time can be precisely and favorably indicated.

When the time indicated by the pointer 5 is different from the standard time, since the pointer position of the pointer 5 can be detected by the pointer position detecting section (not shown) of the gear train mechanism 8, the time indicated by the pointer 5 can be corrected.

That is, the pointer position detecting section can calculate the difference between the time indicated by the pointer 5 and the standard time by detecting the detection hole formed in one of the plural gears of the gear train mechanism 8 by using a detection element.

By the stepping motor 7 being driven and the pointer 5 being moved based on the result of the calculation, the time can be favorably corrected with high precision.

In this wristwatch, since the magnetic poles of the magnet 14 is magnetized having a fixed positional relationship relative to the gear section 15, the rotation position of the magnet 14 of the rotor 12 and the rotation position of the gear 17 of the gear section 15 can be always kept in a fixed positional relationship with each other, and the polarization line R of the magnet 14 and the two opposing teeth sections 17a of the gear 17 can coincide with each other.

Accordingly, the polarization line R of the magnet 14 and the two opposing teeth sections 17a of the gear 17 in this state can precisely coincide with the pair of notches 11b of the stator section 11.

Therefore, the rotation position of the magnet 14 of the rotor 12 and an indication position indicated by the pointer 5 can coincide with each other when the rotor 12 of the stepping motor 7 is rotated and the pointer 5 is moved.

With this, in order to improve the detection accuracy of the pointer position detecting section, the detection hole in one of the plural gears of the gear train mechanism 8 is formed having a small size and thereby prevented from being in a half-opened state in which only the half of the detection hole is closed, which makes it possible to unfailingly detect the detection hole formed in one of the gears of the gear train mechanism 8 by the detection element of the pointer position detecting section (not shown), and to accurately correct the pointer position of the pointer 5.

As such, in this wristwatch, by the detection hole in one of the plural gears of the gear train mechanism 8 being formed smaller, the gear having this detection hole can be formed smaller.

As a result, the plural gears of the gear train mechanism 8 can be formed smaller. Accordingly, the entire gear train mechanism 8 can be made compact and a watch movement 6 can be miniaturized, by which the entire watch size can be miniaturized.

### Second Embodiment

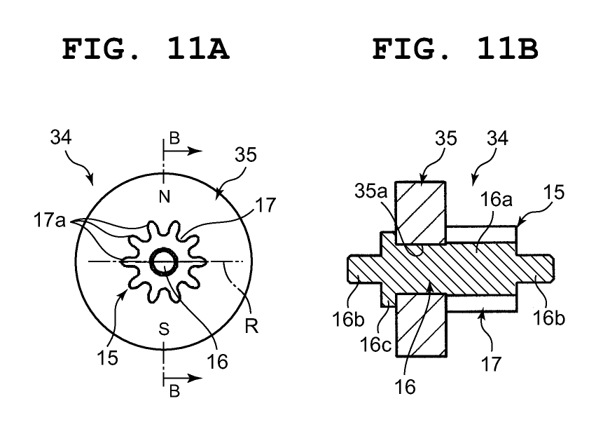

Next, a second embodiment in which the present invention has been applied to a wristwatch is described with reference to FIG. 11A to FIG. 14B.

Note that sections that are the same as those described in the first embodiment with reference to FIG. 1 to FIG. 10B are indicated by the same reference numerals.

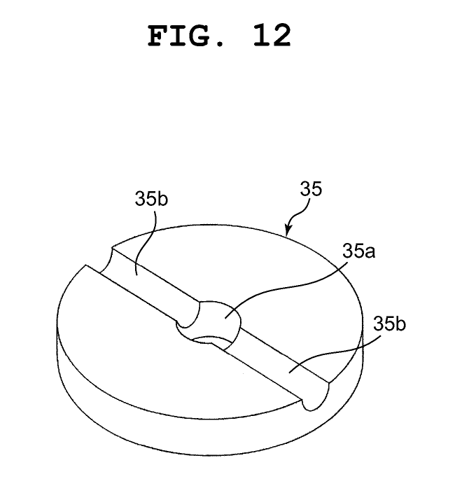

This wristwatch has a structure which is substantially the same as that of the first embodiment except that a magnet 35 of a rotor 34 for the stepping motor 7 has a structure different from that of the first embodiment, as shown in FIG. 11A, FIG. 11B and FIG. 12.

Specifically, the magnet 35 has a shaft hole 35a formed in its rotation center in a manner to penetrate therethrough, and a pair of position regulating sections 35b formed on one surface (upper surface in FIG. 12) of the magnet 35 along the polarization line R dividing the two magnetic poles, as shown in FIG. 11A, FIG. 11B and FIG. 12.

These position regulating sections 35b are grooves each having a semicircular cross-sectional shape, and formed on the two sides of the shaft hole 35a so as to be located on a straight line passing through the center of the shaft hole 35a in a radial direction.

On the magnet 35, the gear section 15 is integrally formed, as in the case of the first embodiment.

This gear section 15 has the shaft section 16 and the gear 17, and the gear 17 is formed having a fixed positional relationship relative to the magnetic poles (NS) of the magnet 35.

That is, the gear 17 is formed having a positional relationship where two opposing teeth sections 17a, that is, two teeth sections 17a located on a straight line passing through the center of the gear 17 in a radial direction are positioned on the polarization line R dividing the two magnetic poles of the magnet 35, as in the case of the first embodiment.

As a result, the rotor 34 is structured such that, when the magnet 35 is arranged in the rotor hole 11a of the stator section 11, the magnet 35 and the gear section 15 are integrally rotated centering on the shaft portion 16 of the gear section 15 in a state where the extending line of the polarization line R dividing the two magnetic poles of the magnet 35 are coinciding with the pair of notches 11b formed on the inner circumferential surface of the rotor hole 11a, as in the case of the first embodiment.

Next, a method for manufacturing this rotor 34 is described.

First, a magnetic material is sintered while a magnetic field being applied thereto, and thereby a magnet element 35c having a recognition mark portion 35d that makes the magnetic pole (NS) direction recognizable is formed, as in the case of the first embodiment.

That is, in this first process, magnetic material powder that serves as material for the magnet element 35c is filled into the sintering metal mold 20, and sintered in this state while a magnetic field and a pressure are being applied thereto. As a result, the magnet element 35c having the recognition mark portion 35d that makes the magnetic pole direction recognizable is formed.

In the sintering of the magnetic material powder in the sintering metal mold 20, the magnetic material powder inside the sintering metal mold 20 is compressed and sintered while a magnetic field is being applied by an electromagnet 21 formed on the outer circumference of the sintering metal mold 17, as in the case of the first embodiment.

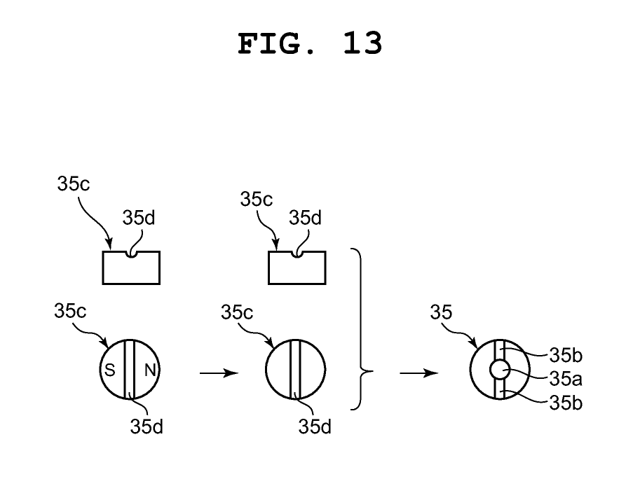

As a result, the magnet element 35c having a circular shape is formed, as shown in FIG. 13.

This magnet element 35c has magnetic poles (NS) formed on the end portions of a straight line passing through the rotation center of the magnet element 35c in a radial direction, that is, end portions in the diameter direction, and the recognition mark portion 35d having a semicircular cross-sectional shape which has been formed along the polarization line R dividing the two magnetic poles.

Then, the magnet element 35c is taken out of the sintering metal mold 20, and subjected to a demagnetization process by a demagnetizing device (not shown), as in the case of the first embodiment.

In this state, the magnetic poles remain in the magnet element 35c as magnetic poles after the demagnetization.

Next, the demagnetized magnet 35 is subjected to a cutting process so that a shaft hole 35a is formed in the rotation center portion of the magnet 35, and the recognition mark portion 35d is formed as the pair of position regulating sections 35b, as shown in FIG. 13.

Here, the shaft hole 35a is formed by the cutting process with the magnet element 35c being positionally regulated by the recognition mark portion 35d formed along the polarization line R dividing the two magnetic poles of the magnet 35.

In addition, the recognition mark portion 35d is subjected to finishing processing and thereby formed on the sides of the shaft hole 35a as the pair of position regulating sections 35b. Note that the recognition mark portion 35d may be used as it is, as the pair of position regulating sections 35b.

Next, in the second process, the direction of each magnetic pole of the magnets 35 after the demagnetization is aligned to one direction by the pair of position regulating sections 35b while the magnets 35 are being transported, and then the magnets 35 are successively arranged, as in the case of the first embodiment.

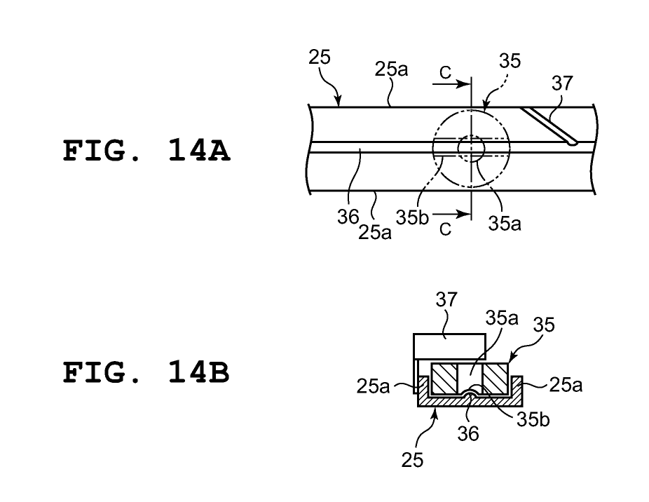

That is, in the second process, the position regulating sections 35b of each magnet 35 are positionally regulated by the transporting device 22 while the magnets 35 in a demagnetized state are being transported by the transporting device 22, as shown in FIG. 14A and FIG. 14B.

As a result, the magnets 35 are successively arranged with the direction of each magnetic pole thereof after the demagnetization being aligned to one direction.

In this embodiment, a guide rail section 36 for positionally regulating the position regulating sections 35b of the magnets 35 is provided on the alignment section 25 of the transporting device 22 serving as a parts feeder. The directions of the magnets 35 are aligned to one direction by this guide rail section 36, and these magnets 35 are then successively arranged, as shown in FIG. 14A and FIG. 14B.

Here, in a case where the position regulating sections 35b of a magnet 35 have not been positionally regulated by the guide rail section 36 or a magnet 35 has been inverted upside down, this magnet 35 is eliminated from the alignment section 25 by a height-regulating plate 37 formed on the alignment section 25.

Next, in the third process, the gear section 15 is formed on the magnet 35 whose direction of each magnetic pole after the demagnetization has been aligned to one direction, with a fixed positional relationship relative to the magnetic pole of the magnet 35 after the demagnetization, and then the magnet 35 is subjected to magnetization processing in this state, as in the case of the first embodiment.

That is, in this third process as well, the magnet 35 whose direction of each magnetic pole after the demagnetization has been aligned to one direction is positionally regulated by the position regulating sections 35b, and then arranged inside the resin molding metal mold 26, as in the case of the first embodiment.

In this embodiment as well, the resin molding metal mold 26 includes the lower metal mold 27 and the upper metal mold 28, in which the hollow section (cavity) 29 for forming the gear section 15 is formed, as in the case of the first embodiment.

In the hollow section 29 of the lower metal mold 27, a magnet arranging section in which the magnet 35 is arranged and which positionally regulates the position regulating sections 35b of the magnet 35 is formed.

As a result, in the resin-molding metal mold 26, when the magnet 35 is placed into the hollow section 29 of the lower metal mold 27, it is positionally regulated by the position regulating sections 35b and arranged on the magnet arranging section, as in the case of the first embodiment. In this state, when the lower metal mold 27 and the upper metal mold 28 are closed and superposed on each other, and resin is injected into the hollow section 29 from the gate section 30 of the upper metal mold 28, the gear section 15 is integrally formed with the magnet 35, as in the case of the first embodiment.

Here, the gear section 15 is formed having a fixed positional relationship relative to the magnetic poles of the magnet 35 after the demagnetization.

That is, the gear 17 of the gear section 15 is formed having a positional relationship where two opposing teeth sections 17a, that is, two teeth sections 17a located on a straight line passing through the center of the gear 17 in a radial direction are positioned on the polarization line R dividing the two magnetic poles of the magnet 35.

Then, the magnet 35 and the gear section 15 integrally formed therewith are taken out of the resin molding metal mold 26, and the taken-out magnet 35 is subjected to magnetization processing by the magnetizing device 31.

Here, the magnet 35 is rotatably arranged between the pair of electromagnets 31a of the magnetizing device 31, and magnetized with its magnetic poles after the demagnetization coinciding with magnetic poles generated by the electromagnets 31a, as in the case of the first embodiment.

In this embodiment as well, even if the N pole of the magnetic poles of the magnet 35 after the demagnetization is at a position slightly shifted from the S pole of the electromagnets 31a and the S pole of the magnetic poles of the magnet 35 after the demagnetization is at a position slightly shifted from the N pole of the electromagnets 31a, the magnetic poles of the magnet 35 after the demagnetization are attracted by the magnetic poles generated by the electromagnets 31a so that the magnet 35 is rotated.

Accordingly, the magnetic poles of the magnet 35 after the demagnetization and the magnetic poles of the electromagnets 31a coincide with each other.

As a result, the rotor 34 in which the magnetic poles of the magnet 35 have been magnetized with a fixed positional relationship relative to the gear section 15 can be acquired.

As such, in this method for manufacturing the rotor 34, each of the magnets 35 on which the pair of position regulating sections 35b have been symmetrically formed relative to the magnetic poles in the first process is demagnetized, whereby the magnets 14 are prevented from being attracted to each other in the second process, as in the case of the first embodiment.

Since the magnets 35 can be individually transported thereby in the second process, the direction of each magnetic pole of the magnets 35 after the demagnetization can be aligned to one direction by the position regulating sections 35b, and the magnets 35 can be successively arranged.

As a result, in the third process, when the gear section 15 is to be formed on the magnet 35 whose direction of each magnetic pole after the demagnetization has been aligned to one direction, the gear section 15 can be precisely positioned with a fixed positional relationship relative to the magnetic poles of the magnet 35 after the demagnetization.

Accordingly, the gear section 15 is precisely formed relative to the magnetic poles of the magnet 35, whereby the productivity is improved and good productivity is achieved.

In this embodiment, in the first process, magnetic material powder is filled into the sintering metal mold 20 and sintered in this state while a magnetic field is being applied thereto, by which the magnet element 35c having the recognition mark portion 35d that makes the magnetic pole direction recognizable can be easily formed.

Then, after the magnet element 35c is taken out of the sintering metal mold 20 and subjected to a demagnetization process, the shaft hole 35a can be formed in the rotation center of the magnet element 350 by a cutting process and the pair of position regulating sections 35b can be formed on the magnet element 35c.

That is, since the magnet element 35c molded in the sintering metal mold 20 has the recognition mark portion 35d which makes the magnetic pole direction recognizable, the magnetic pole direction of the magnet element 35c can be recognized by this recognition mark portion 35d.

Accordingly, in the cutting process on the magnet element 35c after the demagnetization process, the shaft hole 35a can be precisely and easily formed in the center of the magnet element 35c, and the pair of position regulating sections 35b can be precisely and easily formed on the polarization line R dividing the two magnetic poles of the magnet element 35c.

Here, the cutting process is performed with the magnet element 35c being positionally regulated by the recognition mark portion 35d formed along the polarization line R dividing the two magnetic poles of the magnet 35, so that the shaft hole 35a can be precisely formed.

Also, by finishing processing being performed on the recognition mark portion 35d, the recognition mark portion 35d can be easily and precisely formed on the sides of the shaft hole 35a as the pair of position regulating sections 35b. Alternatively, the recognition mark portion 35d can be used as it is, as the pair of position regulating sections 35b.

As a result, the magnet 35 having the pair of position regulating sections 35b formed along the polarization line R dividing the two magnetic poles can be formed with high precision.

Also, in the second process, the transporting device 22 for transporting the magnets 35 in a demagnetized state positionally regulates the position regulating sections 35b of each magnet 35 while transporting the magnets 35.

Therefore, the magnets 35 can be transported by the transporting device 22 without being attracted to each other, and the direction of each magnetic pole of the magnets 35 after the demagnetization can be aligned to one direction, whereby the magnets 35 can be successively arranged.

In this embodiment as well, the transporting device 22 is a parts feeder structured such that the magnets 35 placed into the hopper section 24 are sent to the alignment section 25 by the hopper section 24 being vibrated by the vibration generating section 23, and the directions of the magnets 35 are aligned in the alignment section 25 so that the magnets 35 are aligned in one row.

Therefore, the plural magnets 35 placed into the hopper section 24 can be successively sent to the alignment section 25 one by one, and the directions of the plural magnets 35 can be individually aligned in the alignment section 25 one by one so as to be arranged, as in the case of the first embodiment.

Also, in the third process, when the magnet 35 whose direction of each magnetic pole after the demagnetization has been aligned to one direction is to be arranged inside the resin molding metal mold 26, it can be positionally regulated by the position regulating sections 35b and then arranged therein, as in the case of the first embodiment.

In this state, by resin being injected into the resin molding metal mold 26, the gear section 15 can be formed having a fixed positional relationship relative to the magnetic poles of the magnet 35 after the demagnetization.

Then, by the magnet 35 on which the gear section 15 has been formed being subjected to magnetization processing in accordance with the magnetic poles after the demagnetization, it can be precisely magnetized.

That is, the magnet 35 has been positionally adjusted and arranged inside the resin molding metal mold 26 with its direction being aligned by the position regulating sections 35b.

Therefore, the gear 17 of the gear section 15 can be precisely formed having the positional relationship where two opposing teeth sections 17a, that is, two teeth sections 17a located on a straight line passing through the center of the gear 17 in a radial direction are positioned on the polarization line R of the magnet 35.

Moreover, after the magnet 35 and the gear section 15 integrally formed therewith are taken out of the resin molding metal mold 26, when the taken-out magnet 35 is to be magnetized by the magnetizing device 31, the magnet 35 is rotatably arranged between the pair of electromagnets 31a of the magnetizing device 31, and magnetized with its magnetic poles after the demagnetization coinciding with magnetic poles generated by the electromagnets 31a, whereby the magnet 35 can be precisely and unfailingly magnetized, as in the case of the first embodiment.

In this case as well, even if the magnetic poles of the magnet 35 after the demagnetization are at positions slightly shifted from the magnetic poles of the electromagnets 31a, the magnetic poles of the magnet 35 after the demagnetization are attracted by the magnetic poles generated by the electromagnets 31a of the magnetizing device 31, and whereby the magnet 35 is rotated. Accordingly, the magnet 35 can be precisely and unfailingly magnetized with its magnetic poles having a fixed positional relationship relative to the gear section 15.

This rotor 34, in which a magnetic field generated by the coil section 10 is directed by the stator section 11 and which is rotated by the directed magnetic field, includes the magnet 35 having the pair of position regulating sections 35b formed symmetrically with the magnetic poles thereof and the shaft hole 35a formed in the rotation center thereof, and the gear section 15 in which the gear 17 has been formed in the shaft section 16 in the shaft hole 35a of the magnet 35 with a fixed positional relationship relative to the magnetic poles of the magnet 35.

Accordingly, with the rotation position of the magnetic poles of the magnet 35 and the rotation position of the gear 17 of the gear section 16 having a fixed positional relationship, they can be precisely rotated, as in the case of the first embodiment.

That is, in the stepping motor 7 using this rotor 34, the rotor 34 can be arranged inside the rotor hole 11a of the stator section 11 with the polarization line R, which is dividing the two magnetic poles of the magnet 35 of the rotor 34, precisely coinciding with the pair of notches 11b formed on the inner circumferential surface of the rotor hole 11a of the stator section 11, as in the case of the first embodiment.

As a result, when an alternating magnetic field is generated in the coil section 10 and directed toward the rotor 34 by the stator section 11, the magnet 35 of the rotor 34 can be rotated step by step by 180 degrees inside the rotor hole 11a of the stator section 11 in response to the directed alternating magnetic field.

Thus, with the rotation position of the magnetic poles of the magnet 35 and the rotation position of the gear 17 of the gear section 16 having a fixed positional relationship, they can be precisely and consistently rotated.

Also, in a wristwatch using this stepping motor 7, when the rotor 34 of the stepping motor 7 is rotated, the gear 17 formed on the gear section 15 of the rotor 34 is rotated and the rotation of the gear 17 is successively transmitted by the plural gears of the gear train mechanism 8, whereby the pointer axis (not shown) is rotated, as in the case of the first embodiment.

As a result, the pointer 5 is moved above the dial plate 4, and precisely and favorably indicates the time.

Also, in this wristwatch, when the time indicated by the pointer 5 is different from the standard time, this time indicated by the pointer 5 can be corrected since the pointer position of the pointer 5 can be detected by the pointer position detecting section (not shown) of the gear train mechanism 8, as in the case of the first embodiment.

That is, the pointer position detecting section can calculate the difference between the time indicated by the pointer 5 and the standard time by detecting the detection hole formed in one of the plural gears of the gear train mechanism 8 by using the detection element.

By the stepping motor 7 being driven and the pointer 5 being moved based on the result of the calculation, the time can be favorably corrected with high precision.

In this case as well, the magnetic poles of the magnet 35 are magnetized with a fixed positional relationship relative to the gear section 15, as in the case of the first embodiment.

Therefore, the rotation position of the magnet 35 of the rotor 34 and the rotation position of the gear 17 of the gear section 15 can be always kept in a fixed positional relationship, and the polarization line R of the magnet 35 and two teeth sections 17a of the gear 17 opposing each other can coincide with each other, which can precisely coincide with the pair of notches 11b of the stator section 11.

Accordingly, the rotation position of the magnet 35 of the rotor 34 and an indication position indicated by the pointer 5 can coincide with each other when the rotor 34 of the stepping motor 7 is rotated and the pointer 5 is moved.

With this, in order to improve the detection accuracy of the pointer position detecting section, the detection hole in one of the plural gears of the gear train mechanism 8 is formed having a small size and thereby prevented from being in a half-opened state in which only the half of the detection hole is closed, which makes it possible to unfailingly detect the detection hole formed in one of the gears of the gear train mechanism 8 by the detection element of the pointer position detecting section (not shown), and to accurately correct the pointer position of the pointer 5, as in the case of the first embodiment.

As such, in this wristwatch as well, by the detection hole in one of the plural gears of the gear train mechanism 8 being formed smaller, the gear having this detection hole can be formed smaller. As a result, the plural gears of the gear train mechanism 8 can be formed smaller. Accordingly, the entire gear train mechanism 8 can be made compact and a watch movement 6 can be miniaturized, by which the entire watch size can be miniaturized, as in the case of the first embodiment.

In the magnet 35 in the above-described second embodiment, the recognition mark portion 35d that makes the magnetic pole direction recognizable is used as the pair of position regulating sections 35b. However, the present invention is not limited thereto. For example, a structure may be adopted in which the pair of position regulating sections 14b having the same shape as that of the first embodiment are formed at the ends of the recognition mark portion 35d formed on the polarization line R.

### Third Embodiment

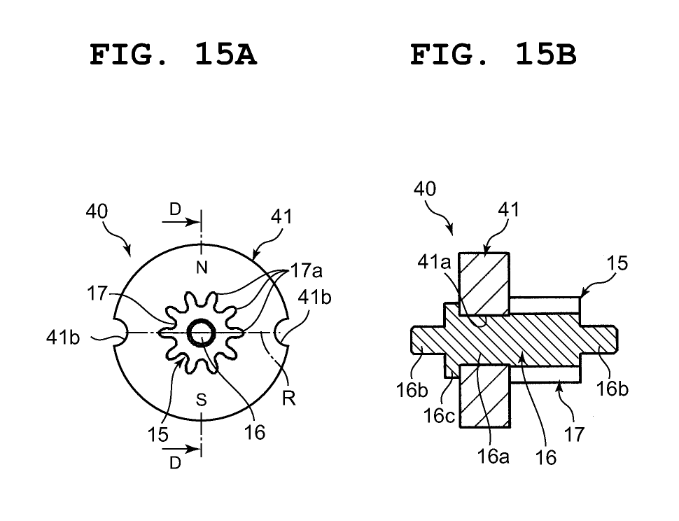

Next, a third embodiment in which the present invention has been applied to a wristwatch is described with reference to FIG. 15A to FIG. 18.

In this embodiment as well, sections that are the same as those described in the first embodiment with reference to FIG. 1 to FIG. 10B are indicated by the same reference numerals.

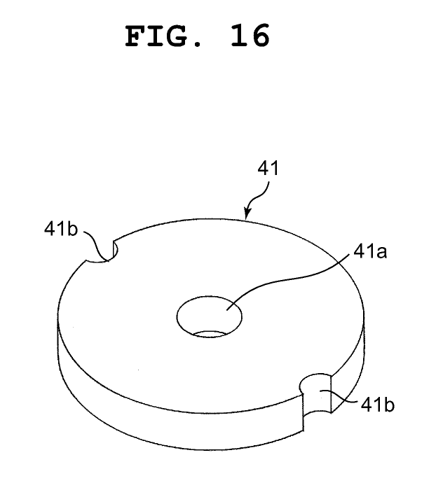

This wristwatch has a structure which is substantially the same as that of the first embodiment except that a magnet 41 for a rotor 40 for the stepping motor 7 has a structure different from that of the first embodiment, as shown in FIG. 15A and FIG. 15B as well as FIG. 16.

Specifically, the magnet 41 has a shaft hole 41a formed in its rotation center in a manner to penetrate therethrough, and a pair of position regulating sections 41b formed in portions of the outer circumferential surface of the magnet 41 which are located on the polarization line R dividing the two magnetic poles of the magnet 41, as shown in FIG. 15A, FIG. 15B and FIG. 16.

These position regulating sections 41b are concave sections each having a semicircular shape, and formed on the polarization line R that is a straight line passing through the center of the shaft hole 41a in a radial direction.

Also, the gear section 15 is integrally formed on the magnet 41, as in the case of the first embodiment.

This gear section 15 has the shaft section 16 and the gear 17, and the gear 17 is formed having a fixed positional relationship relative to the magnetic poles (NS) of the magnet 41.

That is, the gear 17 is formed having a positional relationship where two opposing teeth sections 17a, that is, two teeth sections 17a located on a straight line passing through the center of the gear 17 in a radial direction are positioned on the polarization line R dividing the two magnetic poles of the magnet 41, as in the case of the first embodiment.

As a result, the rotor 40 is structured such that, when the magnet 41 is arranged in the rotor hole 11a of the stator section 11, the magnet 35 and the gear section 15 are integrally rotated centering on the shaft portion 16 of the gear section 15 in a state where the extending line of the polarization line R dividing the two magnetic poles of the magnet 41 are coinciding with the pair of notches 11b formed on the inner circumferential surface of the rotor hole 11a, as in the case of the first embodiment.

Next, a method for manufacturing this rotor 40 is described.

First, in the first process, a magnetic material is sintered while a magnetic field being applied thereto, and thereby a magnet element 410 having recognition mark portions 41d that make the magnetic pole (NS) direction recognizable is formed.

That is, in this first process, magnetic material powder that serves as material for the magnet element 41c is filled into the sintering metal mold 20, and sintered in this state while a magnetic field and a pressure are being applied thereto. As a result, the magnet element 41c having the pair of recognition mark portions 41d that make the magnetic pole direction recognizable is formed.

In the sintering of the magnetic material powder in the sintering metal mold 20, the magnetic material powder inside the sintering metal mold 20 is compressed and sintered while a magnetic field is being applied by the electromagnet 21 formed on the outer circumference of the sintering metal mold 17, as in the case of the first embodiment.

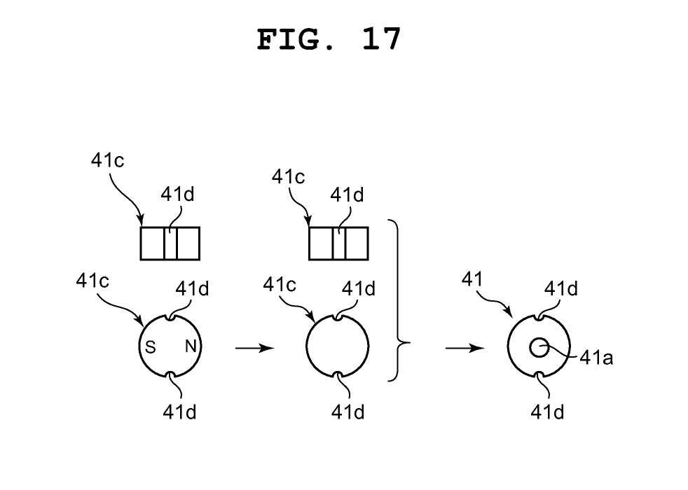

As a result, the magnet element 41c having a circular shape is formed, as shown in FIG. 17.

This magnet element 41c has magnetic poles (NS) formed on the end portions of a straight line passing through the rotation center of the magnet element 41c in a radial direction, that is, end portions in the diameter direction, and the pair of recognition mark portions 41d each having a semi-circular concave shape are formed at the ends of the polarization line R dividing the two magnetic poles.

Then, as with the first embodiment, the magnet element 41c is taken out of the sintering metal mold 20 and subjected to a demagnetization process by a demagnetizing device (not shown), as shown in FIG. 17.

In this state, the magnetic poles remain in the magnet element 41c as magnetic poles after the demagnetization.

Next, the demagnetized magnet element 41c is subjected to a cutting process so that the shaft hole 41a is formed in the rotation center portion of the magnet element 41c, and the pair of position regulating sections 41b are formed.

Here, the shaft hole 41a is formed by a cutting process with the magnet element 41 being positionally regulated by the pair of recognition mark portions 41d formed on the ends of the polarization line R dividing the two magnetic poles.

In addition, the pair of recognition mark portions 41d are subjected to finishing processing and thereby formed as the pair of position regulating sections 41b. Note that the pair of recognition mark portions 41d may be used as they are, as the pair of position regulating sections 41b.

As a result, the magnet 41 is formed.

Next, in the second process, the direction of each magnetic pole of the magnets 41 after the demagnetization is aligned to one direction by the pair of position regulating sections 41b while the magnets 41 are being transported, and then the magnets 41 are successively arranged, as in the case of the first embodiment.

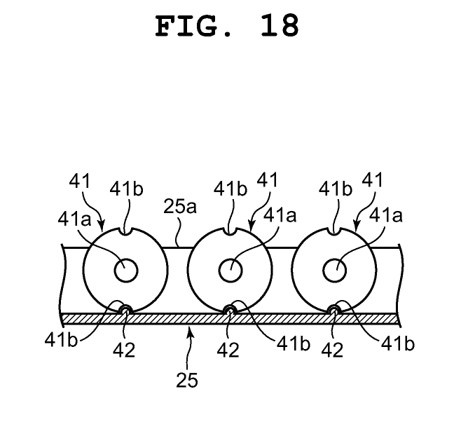

That is, in the second process, the position regulating sections 41b of each magnet 41 are positionally regulated by the transporting device 22 while the magnets 41 in a demagnetized state are being transported by the transporting device 22, as shown in FIG. 18.

As a result, the magnets 41 are successively arranged with the direction of each magnetic pole thereof after the demagnetization being aligned to one direction.

In this embodiment, the alignment section 25 of the transporting device 22 serving as a parts feeder is formed to be gradually tilted toward the forward direction so that the magnets 41 are gradually tilted while being moved in the forward direction, and the positions of the position regulating sections 41b of each tilted magnet 41 are successively regulated by a plurality of position regulating projections 42 formed on the alignment section 25 at predetermined intervals, as shown in FIG. 18.

As a result, the magnets 41 are successively sent out from the alignment section 25 with their directions being aligned to one direction, and arranged in a successively stacked state.

Next, in the third process, the gear section 15 is formed on the magnet 41 whose direction of each magnetic pole after the demagnetization has been aligned to one direction, with a fixed positional relationship with the magnetic poles of the magnet 41 after the demagnetization, and then the magnet 41 is subjected to magnetization processing in this state, as in the case of the first embodiment.

That is, in this third process as well, the magnet 41 whose direction of each magnetic pole after the demagnetization has been aligned to one direction is positionally regulated by the position regulating sections 41b, and then arranged inside the resin molding metal mold 26, as in the case of the first embodiment.

In this embodiment as well, the resin molding metal mold 26 includes the lower metal mold 27 and the upper metal mold 28, in which the hollow section (cavity) 29 for forming the gear section 15 is formed, as in the case of the first embodiment.

In the hollow section 29 of the lower metal mold 27, a magnet arranging section in which the magnet 41 is arranged and which positionally regulates the position regulating sections 41b of the magnet 41 is formed.

As a result, in the resin-molding metal mold 26, when the magnet 41 is placed into the hollow section 29 of the lower metal mold 27, it is positionally regulated by the position regulating sections 41b and arranged on the magnet arranging section, as in the case of the first embodiment. In this state, when the lower metal mold 27 and the upper metal mold 28 are closed and superposed on each other, and resin is injected into the hollow section 29 from the gate section 30 of the upper metal mold 28, the gear section 15 is integrally formed with the magnet 41, as in the case of the first embodiment.

Here, the gear section 15 is formed having a fixed positional relationship relative to the magnetic poles of the magnet 41 after the demagnetization.

That is, the gear 17 of the gear section 15 is formed having a positional relationship where two opposing teeth sections 17a, that is, two teeth sections 17a located on a straight line passing through the center of the gear 17 in a radial direction are positioned on the polarization line R dividing the two magnetic poles of the magnet 41.

Then, the magnet 41 and the gear section 15 integrally formed therewith are taken out of the resin molding metal mold 26, and the taken-out magnet 41 is subjected to magnetization processing by the magnetizing device 31.

Here, the magnet 41 is rotatably arranged between the pair of electromagnets 31a of the magnetizing device 31, and magnetized with its magnetic poles after the demagnetization coinciding with magnetic poles generated by the electromagnets 31a, as in the case of the first embodiment.

In this embodiment as well, even if the N pole of the magnetic poles of the magnet 41 after the demagnetization is at a position slightly shifted from the S pole of the electromagnets 31a and the S pole of the magnetic poles of the magnet 41 after the demagnetization is at a position slightly shifted from the N pole of the electromagnets 31a, the magnetic poles of the magnet 41 after the demagnetization are attracted by the magnetic poles generated by the electromagnets 31a so that the magnet 41 is rotated.

Accordingly, the magnetic poles of the magnet 41 after the demagnetization and the magnetic poles of the electromagnets 31a coincide with each other.

As a result, the rotor 40 in which the magnetic poles of the magnet 41 have been magnetized with a fixed positional relationship relative to the gear section 15 can be acquired.

As such, in this method for manufacturing the rotor 40, each of the magnets 41 in which the pair of position regulating sections 41b have been symmetrically formed relative to the magnetic poles in the first process is demagnetized, whereby the magnets 41 are prevented from being attracted to each other in the second process, as in the case of the first embodiment.

Since the magnets 41 can be individually transported thereby in the second process, the direction of each magnetic pole of the magnets 41 after the demagnetization can be aligned to one direction by the position regulating sections 41b, and the magnets 41 can be successively arranged.

As a result, in the third process, when the gear section 15 is to be formed on the magnet 41 whose direction of each magnetic pole after the demagnetization has been aligned to one direction, the gear section 15 can be precisely positioned with a fixed positional relationship relative to the magnetic poles of the magnet 41 after the demagnetization.

Accordingly, the gear section 15 is precisely formed relative to the magnetic poles of the magnet 41, whereby the productivity is improved.

In this embodiment, in the first process, magnetic material powder is filled into the sintering metal mold 20 and sintered in this state while a magnetic field is being applied thereto, by which the magnet element 41c having the pair of recognition mark portions 41d that make the magnetic pole direction recognizable can be easily formed.

Then, after the magnet element 41c is subjected to a demagnetization process, the shaft hole 41a can be formed in the rotation center of the magnet element 41c by a cutting process and the pair of position regulating sections 41b can be formed in the magnet element 41c.

That is, since the magnet element 41c molded in the sintering metal mold 20 has the recognition mark portions 41d which make the magnetic pole direction recognizable, the magnetic pole direction of the magnet element 41c can be recognized by these recognition mark portions 41d.

Accordingly, in the cutting process on the magnet element 41c after the demagnetization process, the shaft hole 41a can be precisely and easily formed in the center of the magnet element 41c, and the pair of position regulating sections 41b can be precisely and easily formed on the polarization line R dividing the two magnetic poles of the magnet element 41c.

Here, the cutting process is performed with the magnet element 41c being positionally regulated by the recognition mark portions 41d formed at the ends of the polarization line R dividing the two magnetic poles of the magnet 41, so that the shaft hole 41a can be precisely formed.

Also, by finishing processing being performed on the pair of recognition mark portions 41d, they can be easily and precisely formed as the pair of position regulating sections 41b. Alternatively, the pair of recognition mark portions 41d can be used as they are, as the pair of position regulating sections 41b.

As a result, the magnet 41 having the pair of position regulating sections 41b formed along the polarization line R dividing the two magnetic poles can be formed with high precision.

Also, in the second process, the transporting device 22 for transporting the magnets 41 in a demagnetized state positionally regulates the position regulating sections 41b of each magnet 41 while transporting the magnets 41.

Therefore, the magnets 41 can be transported by the transporting device 22 without being attracted to each other, and the direction of each magnetic pole of the magnets 41 after the demagnetization can be aligned to one direction, whereby the magnets 41 can be successively arranged.

In this embodiment as well, the transporting device 22 is a parts feeder structured such that the magnets 41 placed into the hopper section 24 are sent to the alignment section 25 by the hopper section 24 being vibrated by the vibration generating section 23, and the directions of the magnets 41 are aligned in the alignment section 25.

Therefore, the plural magnets 41 placed into the hopper section 24 can be successively sent to the alignment section 25 one by one, and the directions of the plural magnets 41 can be individually aligned in the alignment section 25 one by one so as to be arranged, as in the case of the first embodiment.

Also, in the third process, when the magnet 41 whose direction of each magnetic pole after the demagnetization has been aligned to one direction is to be arranged inside the resin molding metal mold 26, it can be positionally regulated by the position regulating sections 41b and then arranged therein, as in the case of the first embodiment. In this state, by resin being injected into the resin molding metal mold 26, the gear section 15 can be formed having a fixed positional relationship relative to the magnetic poles of the magnet 41 after the demagnetization. Then, by the magnet 41 on which the gear section 15 has been formed being subjected to magnetization processing in accordance with the magnetic poles after the demagnetization, it can be precisely magnetized.

That is, the magnet 41 has been positionally adjusted and arranged inside the resin molding metal mold 26 with its direction being aligned by the position regulating sections 41b, and therefore the gear 17 of the gear section 15 can be precisely formed having the positional relationship where two opposing teeth sections 17a, that is, two teeth sections 17a located on a straight line passing through the center of the gear 17 in a radial direction are positioned on the polarization line R of the magnet 41.

Moreover, after the magnet 41 and the gear section 15 integrally formed therewith are taken out of the resin molding metal mold 26, when the taken-out magnet 41 is to be magnetized by the magnetizing device 31, the magnet 41 is rotatably arranged between the pair of electromagnets 31a of the magnetizing device 31, and magnetized with its magnetic poles after the demagnetization coinciding with magnetic poles generated by the electromagnets 31a, whereby the magnet 41 can be precisely and unfailingly magnetized, as in the case of the first embodiment.

In this case as well, even if the magnetic poles of the magnet 41 after the demagnetization are at positions slightly shifted from the magnetic poles of the electromagnets 31a, the magnetic poles of the magnet 41 after the demagnetization are attracted by the magnetic poles generated by the electromagnets 31a of the magnetizing device 31, and whereby the magnet 41 is rotated. Accordingly, the magnet 41 can be precisely and unfailingly magnetized with its magnetic poles having a fixed positional relationship relative to the gear section 15.

This rotor 40, in which a magnetic field generated by the coil section 10 is directed by the stator section 11 and which is rotated by the directed magnetic field, includes the magnet 41 having the pair of position regulating sections 41b formed symmetrically with the magnetic poles thereof and the shaft hole 41a formed in the rotation center thereof, and the gear section 15 in which the gear 17 has been formed in the shaft section 16 in the shaft hole 41a of the magnet 41 with a fixed positional relationship relative to the magnetic poles of the magnet 41.

Accordingly, with the rotation position of the magnetic poles of the magnet 41 and the rotation position of the gear 17 of the gear section 16 coinciding with each other, they can be precisely rotated, as in the case of the first embodiment.

That is, in the stepping motor 7 using this rotor 40, the rotor 40 can be arranged inside the rotor hole 11a of the stator section 11 with the polarization line R, which is dividing the two magnetic poles of the magnet 41 of the rotor 40, precisely coinciding with the pair of notches 11b formed on the inner circumferential surface of the rotor hole 11a of the stator section 11, as in the case of the first embodiment.

As a result, when an alternating magnetic field is generated in the coil section 10 and directed toward the rotor 40 by the stator section 11, the magnet 41 of the rotor 40 can be rotated step by step by 180 degrees inside the rotor hole 11a of the stator section 11 in response to the directed alternating magnetic field.

Thus, with the rotation position of the magnetic poles of the magnet 41 and the rotation position of the gear 17 of the gear section 16 having a fixed positional relationship, they can be precisely rotated.

Also, in a wristwatch using this stepping motor 7, when the rotor 40 of the stepping motor 7 is rotated, the gear 17 formed on the gear section 15 of the rotor 40 is rotated and the rotation of the gear 17 is successively transmitted to the pointer axis (not shown) by the plural gears of the gear train mechanism 8, whereby the pointer axis is rotated and the pointer 5 is moved above the dial plate 4. As a result, the time is precisely and favorably indicated, as in the case of the first embodiment.

Also, in this wristwatch, when the time indicated by the pointer 5 is different from the standard time, this time indicated by the pointer 5 can be corrected since the pointer position of the pointer 5 can be detected by the pointer position detecting section (not shown) of the gear train mechanism 8, as in the case of the first embodiment.

That is, the pointer position detecting section can calculate the difference between the time indicated by the pointer 5 and the standard time by detecting the detection hole formed in one of the plural gears of the gear train mechanism 8 by using the detection element. By the stepping motor 7 being driven and the pointer 5 being moved based on the result of the calculation, the time can be favorably corrected with high precision.

In this case as well, the magnetic poles of the magnet 41 are magnetized with a fixed positional relationship relative to the gear section 15, as in the case of the first embodiment. Therefore, the rotation position of the magnet 41 of the rotor 40 and the rotation position of the gear 17 of the gear section 15 can be kept in a fixed positional relationship, and the polarization line R of the magnet 41 and two teeth sections 17a of the gear 17 opposing each other can be always kept in a fixed positional relationship, which can precisely coincide with the pair of notches 11b of the stator section 11.

Accordingly, the rotation position of the magnet 41 of the rotor 40 and an indication position indicated by the pointer 5 can coincide with each other when the rotor 40 of the stepping motor 7 is rotated and the pointer 5 is moved.

With this, in order to improve the detection accuracy of the pointer position detecting section, the detection hole in one of the plural gears of the gear train mechanism 8 is formed having a small size and thereby prevented from being in a half-opened state in which only the half of the detection hole is closed, which makes it possible to unfailingly detect the detection hole formed in one of the gears of the gear train mechanism 8 by the detection element of the pointer position detecting section (not shown), and to accurately correct the pointer position of the pointer 5, as in the case of the first embodiment.

As such, in this wristwatch as well, by the detection hole in one of the plural gears of the gear train mechanism 8 being formed smaller, the gear having this detection hole can be formed smaller. As a result, the plural gears of the gear train mechanism 8 can be formed smaller, as in the case of the first embodiment.

Accordingly, the entire gear train mechanism 8 can be made compact and the watch movement 6 can be miniaturized, by which the entire watch size can be miniaturized.

In the above-described first to third embodiments, the pair of position regulating sections 14b, 35b and 41b are provided on the polarization line R of each magnet 14, 35 and 41.

However, these position regulating sections are not necessarily required to be provided on the polarization line R, and may be provided at symmetrical positions, such as point symmetry or line symmetry, centered on the shaft hole 14a, 35a or 41a of the magnet 14, 35 or 41.

Also, in the above-described first to third embodiments, a parts feeder is used as the transporting device 22.

However, the parts feeder is not necessarily required to be used, and another transporting device, such as a conveyer belt, may be used.

Moreover, in the above-described first to third embodiments, the present invention is applied to the stepping motor 7 of a wristwatch.

However, the present invention is not necessarily required to be applied to the stepping motor 7 of a wristwatch, and may be applied to the stepping motors of various pointer-type timepieces, such as a travel watch, an alarm clock, a bracket clock, or a wall clock. Also, the present invention may be widely applied to various electromagnetic driving devices, such as stepping motors for use in driving sections of electronic apparatuses, such as cameras or portable telephones.

While the present invention has been described with reference to the preferred embodiments, it is intended that the invention be not limited by any of the details of the description therein but includes all the embodiments which fall within the scope of the appended claims.

What is claimed is:

1. A rotor manufacturing method comprising:
a first step of forming a magnet by (i) forming a magnet element whose magnetic pole direction is recognizable by sintering a magnetic material while applying a magnetic field to the magnetic material, (ii) performing a demagnetization process on the magnet element, and (iii) forming position regulating sections on the magnet element symmetrically relative to magnetic poles;
a second step of aligning a direction of each magnetic pole of the magnet after demagnetization to one direction by the position regulating sections while transporting the magnet so as to successively align magnets; and
a third step of (i) forming a gear section on the magnet whose direction of each magnetic pole after the demagnetization has been aligned to one direction such that the gear section has a fixed positional relationship relative to the position regulating sections after the demagnetization, and (ii) performing magnetization processing on the magnet.

2. The rotor manufacturing method according to claim 1, wherein the first step is a step of forming the magnet by (i) forming the magnet element having an outside shape that makes the magnetic pole direction recognizable by filling powder of the magnetic material into a sintering metal mold and sintering the magnetic material while applying a magnetic field to the magnetic material, (ii) forming a shaft hole in rotation center of the magnet element by performing a demagnetization process and a cutting process on the magnet element, and (iii) forming the position regulating sections on a polarization line dividing the magnetic poles after recognizing the magnetic pole direction based on the outside shape of the magnet element.

3. The rotor manufacturing method according to claim 1, wherein the first step is a step of forming the magnet by (i) forming the magnet element having a recognition mark portion that makes the magnetic pole direction recognizable by filling powder of the magnet element into a sintering metal mold and sintering the magnet element while applying a magnetic field to the magnet element, (ii) forming a shaft hole in rotation center of the magnet element by performing a demagnetization process and a cutting process on the magnet element, and (iii) forming the position regulating sections on a polarization line dividing the magnetic poles after recognizing the magnetic pole direction of the magnet element by the recognition mark portion.

4. The rotor manufacturing method according to claim 1, wherein the second step is a step of aligning the direction of each magnetic pole of the magnet after the demagnetization to one direction by positionally regulating the position regulating section of the magnet by using a transporting device for transporting the magnet in a demagnetized state while transporting the magnet by the transporting device so as to successively align magnets.

5. The rotor manufacturing method according to claim 1, wherein the third step is a step of (i) arranging the magnet whose direction of each magnetic pole after the demagnetization has been aligned to one direction in a molding metal mold after positionally regulating the magnet by the position regulating section, (ii) forming the gear section such that the gear section has a fixed positional relationship relative to the magnetic poles of the magnet after the demagnetization, by injecting resin into the molding metal mold, and (iii) performing magnetization processing on the magnet having the gear section, corresponding to the magnetic poles of the magnet after the demagnetization.

6. A rotor that is rotated in response to a magnetic field generated in a coil section and directed by a stator section, comprising:
a magnet having position regulating sections formed symmetrically relative to magnetic poles, and a shaft hole formed in a rotation center; and
a gear section having a gear formed on a shaft section in the shaft hole of the magnet in a manner to have a fixed positional relationship relative to the position regulating sections.

7. The rotor according to claim 6, wherein the position regulating sections of the magnet have been formed on a polarization line dividing the magnetic poles of the magnet.

8. A timepiece comprising:
a stepping motor having a rotor that includes (i) a magnet having position regulating sections formed symmetrically relative to magnetic poles and a shaft hole formed in a rotation center, and (ii) a gear section having a gear formed on a shaft section in the shaft hole of the magnet in a manner to have a fixed positional relationship relative to the position regulating sections.
